(19) United States
(12) Patent Application Publication
(10) Pub. No.: US 2004/0262243 A1
(43) Pub. Date: Dec. 30, 2004

(54) Method and apparatus for a water filter backflush

(75) Inventor: Robert S. Bosko, San Antonio, TX (US)

Correspondence Address: LAW OFFICES OF CHRISTOPHER L. MAKAY, 1634 Milam Building, 115 East Travis Street, San Antonio, TX, 78205, US

(73) Assignee: LANCER PARTNERSHIP, LTD.

(21) Appl. No.: 10/606,873

(22) Filed: Jun. 26, 2003

(51) Int. Cl. B01D 29/62

(52) U.S. Cl. 210/791; 210/411

(57) ABSTRACT

A method and corresponding apparatus employ purified water to backflush a filtration device. Purified water includes water having a total dissolved solids reading less than that of the water being filtered. Examples of purified water may include water treated using reverse osmosis, steam distillation, or deionization processes, and the like. In the simplest form, the purified water is used to rinse or backflush a filter or filter cartridge. Further extensions include valves to switch from a primary flowpath used for normal operations to a secondary flowpath used to conduct backflushing routines. Backflushing routines may be initiated on demand or through an automated routine that repeats the process on a regular basis.

### BACKGROUND OF THE INVENTION

1. Field of the Invention

The present invention relates to a method and apparatus for backflushing a water filter and, more particularly, but not by way of limitation, to backflushing the water filter with pure water.

2. Description of the Related Art

Water of sufficient quality for human consumption has always been a concern, especially in newly developing countries, and there is a growing concern even in industrialized countries. Water quality issues range from merely reducing water hardness or removing high concentrations of minerals to the dire one of removing contaminants, such as biological or harmful chemicals.

Water quality issues may be addressed through water treatment equipment that employ various methods for purifying water, some in conjunction with others, to obtain a desired grade or level of water quality. Example water treatment methods include reverse osmosis, deionization and steam generation. Water treatment equipment employing these methods typically require a filter in line prior thereto to remove particles up to a preselected size range.

Unfortunately, filters typically have a limited life and are treated as consumables. Filters commonly used in the marketplace contain a filter cartridge that is replaceable. Therein, a service agent or maintenance person must remove and replace the filter cartridge on a scheduled basis. When new, the filter cartridges allow water to pass freely, with minimal pressure buildup. As the filtering process continues, the flow through the filter is reduced due to clogging, calcification and compaction due to continued pressure. Problems with servicing of filters include varying levels of clogging associated with different types of water, as well as varying levels of service available in different areas. In remote or less populated areas, access to service agents is limited. Consequently, the use of filters in a water delivery system can be cost prohibitive and inefficient.

### SUMMARY OF THE INVENTION

In accordance with the present invention, a method and corresponding apparatus employ purified water to backflush a filtration device. Purified water includes water having a total dissolved solids reading less than that of the water being filtered, preferably at least fifty percent less. In the simplest form, purified water is used to rinse or backflush a filter or filter cartridge. Further embodiments include a pressurized flow and a submersing tank to backflush or submerge a filter .

An alternative embodiment includes a primary or filtered flowpath used during normal operations and a secondary flowpath used for backflushing routines, wherein purified water is the source water used for backflushing the filter. Switching a set of valves substantially simultaneously provides the two separate and distinct flowpaths. The use of the secondary flowpath allows purified water to enter the primary flowpath, and move backwards through the filter. The water is then purged from the filtered flowpath to remove concentrations of solids that have been displaced from the filter by the backflushing routine. Switching of the valves may be accomplished manually or a controller may be added to the system to provide the capability of automatically backflushing the filter on a scheduled basis.

It is therefore an object of the present invention to utilize purified water as a cleansing media.

It is a further object of the present invention to provide an apparatus for cleansing a filter using purified water.

It is still further an object of the present invention to provide an apparatus for backflushing a filter in a filtered flowpath using purified water.

It is still yet further an object of the present invention to provide an apparatus for automatically backflushing a filter in a filtered flowpath on a scheduled basis. It is still yet further an object of the present invention to provide a method of automatically backflushing a filter in a filtered flowpath on a scheduled basis.

Still other objects, features, and advantages of the present invention will become evident to those of ordinary skill in the art in light of the following.

### BRIEF DESCRIPTION OF THE DRAWINGS

FIG. 1 illustrates a method of cleansing a filter cartridge.

FIG. 2 illustrates a method of cleansing a filter cartridge using a pressurized flow.

FIG. 3 illustrates a primary flowpath according to the preferred embodiment.

FIG. 4 illustrates a secondary flowpath for a filter backflush unit according to the preferred embodiment.

FIG. 5 is a method flowchart for using the filter backflush unit according to the preferred embodiment.

FIG. 6 illustrates a self-flushing filter backflush unit according to the preferred embodiment.

FIG. 7 provides a method flowchart for using the self-flushing backflush unit according to the preferred embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

The invention at hand is a method and apparatus for backflushing a filtration device with purified water. Purified water includes water having a lower total dissolved solids reading than the water being filtered, preferably with a total dissolved solids reading fifty percent lower than that of the water being filtered, more preferably with a total dissolved solids reading eighty percent lower than that of the water being filtered, and still more preferably with a total dissolved solids reading ninety five percent lower than that of the water being filtered. Those skilled in the art will recognize that purified water may be produced using any suitable purification process, such as reverse osmosis, steam distillation or deionization. Backflushing of a filtration device allows the backflush media to lift compacted particles. Water with a low total dissolved solids reading is essentially unsaturated and able to dissolve particles attached to the filter medium. The particles are then removed from the filter medium through the use of a second flowpath terminating in a sanitary drain or other disposal. Various embodiments of the invention may be employed to extend the life of filters, unclog clogged filters or keep new filters from clogging. Backflushing of a filter may be accomplished manually or through an embodiment of this invention that automatically backflushes a filter on a scheduled basis.

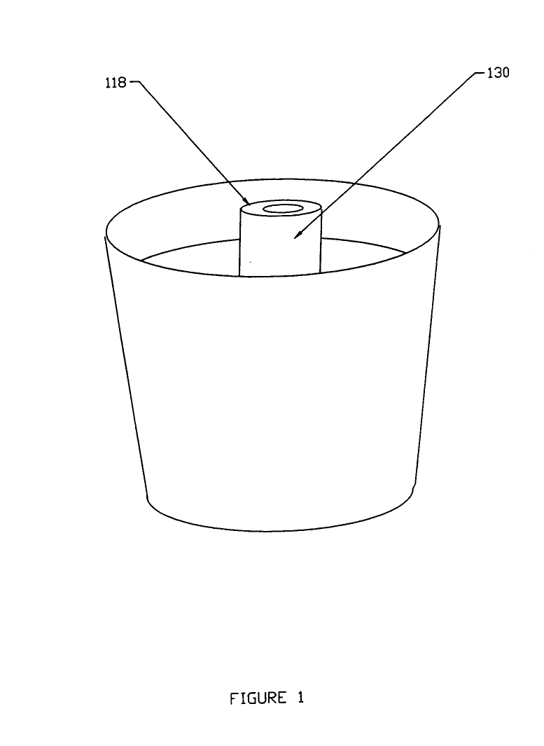

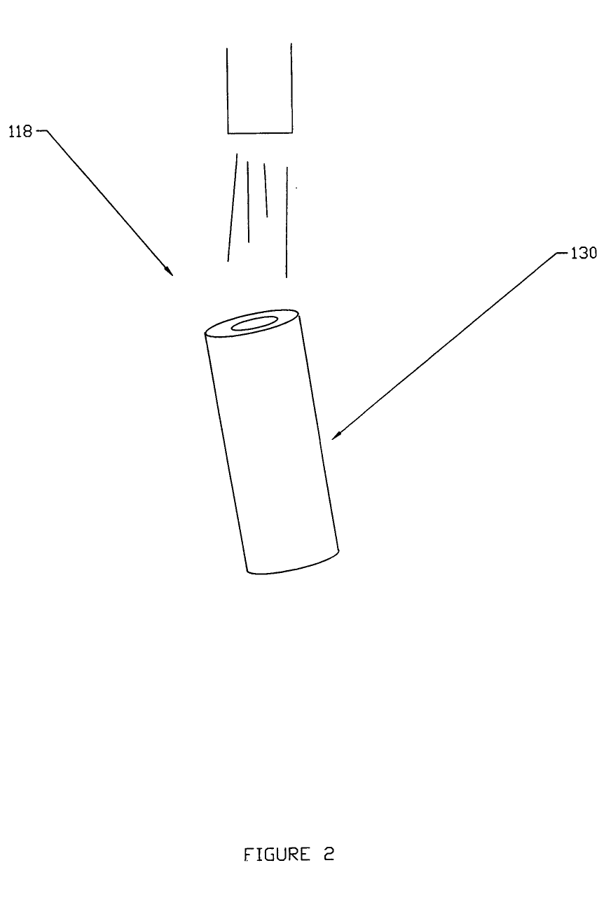

In the simplest form, a filter 101 or a filter cartridge 118 may be removed from a filtered flowpath for cleansing with purified water. Cleansing may take place in various embodiments ranging from submerging the filter cartridge 118 in a container or sink to backflushing the filter cartridge 118 with a hose or a pressure flow system as shown in FIGS. 1 and 2, or a combination of both. Submerging the filter cartridge 118 in purified water dissolves the filtered components clinging to a filter medium 130. In the pressurized flow system, purified water is forced backwards and forwards through the filter cartridge 118, therein dissolving and dislodging particles from the filter medium 130. The pressurized flow further allows the dissolved particles to be transported away from the filter medium 130, therein removing the high concentration of particles from the filtered flowpath.

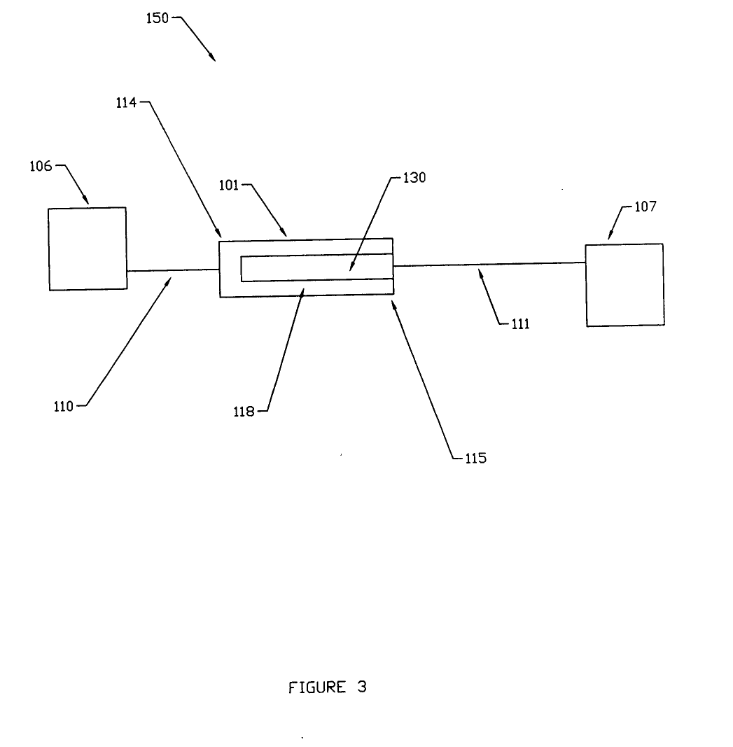

Alternatively, the filter medium 130 may be cleansed in place with a backflush unit 100. The backflush unit 100 includes a primary flowpath 150 and a secondary flowpath 160. As shown in FIG. 3, the primary or filtered flowpath 150 includes a filter 101, a fluid source 106, an inlet pipe 110, an outlet pipe 111 and an end-use device 107. The filter 101 includes the filter medium 130 disposed therein, an inlet end 114 and an outlet end 115, wherein fluids are filtered as they pass through the filter 101 from the inlet end 114, through the filter medium 130 in the filter cartridge 118 to the outlet end 15. The inlet end 114 of the filter 101 is coupled to the inlet pipe 110, which is coupled to the fluid source 106. The outlet end 115 is coupled to an outlet pipe 111, which in turn is coupled to the end-use device 107. Therein, water moves from the fluid source 106 through inlet pipe 110, through the filter 101, and through outlet pipe 111 to the end-use device 107 in the primary flowpath 150 for consumption or use.

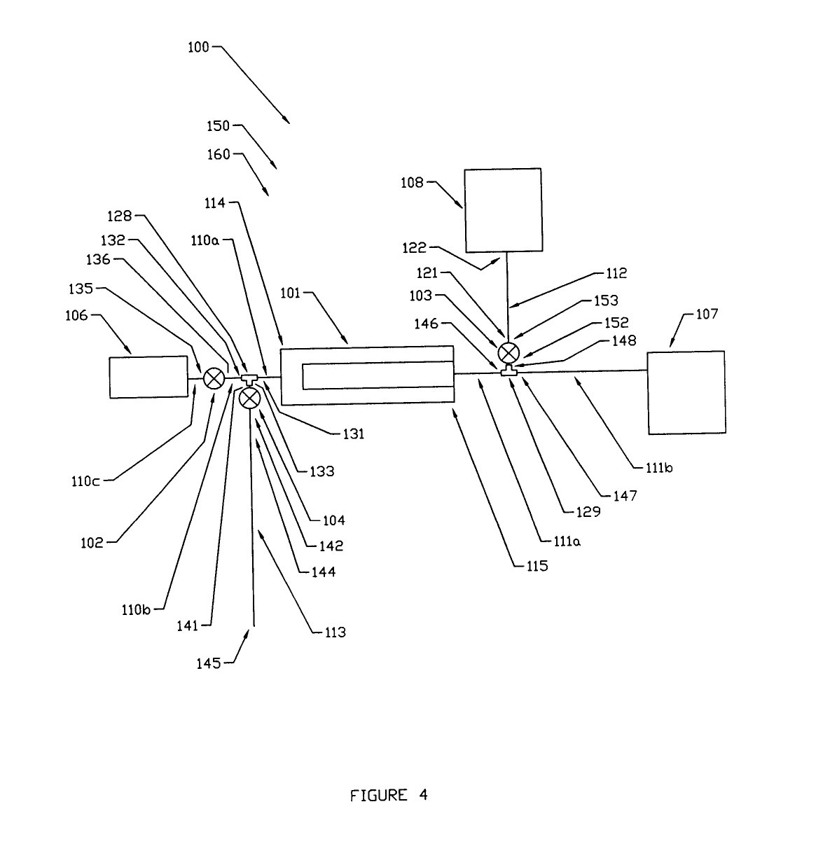

The secondary flowpath 160 may be created from the primary flowpath 150 with the addition of a first tee 128 in the inlet pipe 110 between the inlet valve 102 and the inlet end 114 of the filter 101, a second tee 129 in the outlet pipe 111 near the outlet end 115 of the filter 101 and an inlet valve 102 between the first tee 128 and the fluid source 106 as shown in FIG. 4. A first port 131 and a second port 132 of the first tee 128, therein connect to an inlet pipe 110a or 110b, respectively, while a third port 133 of the first tee 128 connects to a first port 141 of a drain valve 104. A second port 142 of the drain valve 104 connects to an inlet end 144 of a drain pipe 113. An outlet end 145 of the drain pipe 113 is connected to a suitable sanitary disposal or storage device.

The second tee 129 includes a first port 146, a second port 147 and a third port 148. The first port 146 and the second port 147 connect to an outlet pipe 111a or 111b, respectively, and the third port 148 connects to a first port 152 of a flush valve 103. The flush valve 103 further includes a second port 153 connectable to a first end 121 of a flush inlet pipe 112. A second end 122 of the flush inlet pipe 112 is attached to a flush source 108.

The inlet valve 102 includes a first port 135 and a second port 136. The first port 135 is coupled to an inlet pipe 110c, which is attached to the fluid source 106. The second port 136 of the inlet valve 102 is connected to the inlet pipe 110b which further connects to the first port 131 of the first tee 128. Having an on and an off position, the inlet valve 102 provides the ability to stop the flow of fluid from the fluid source 106.

The secondary flowpath 160, used for backflushing and cleansing the filter medium 130 in the filter 101, does not impact the primary flowpath 150 when the inlet valve 102 is in an open position, and the flush valve 103 and the drain valve 104 are in a closed position. In a backflushing or cleansing mode, the inlet valve 102 is in a closed position, and the flush valve 103 and the drain valve 104 are in an open position. Therein, the secondary flowpath 160 allows purified water to flow from the flush source 108 through the flush inlet pipe 112, through the flush valve 103 and into the second tee 129 to gain entrance to the primary flowpath 150. The secondary flowpath 160 continues from the second tee 129, through the outlet pipe 111a, in the outlet end 115 of the filter 101, backwards through the filter medium 130, out the inlet end 114 of the filter 101, through the inlet pipe 110a, through the first tee 128, through the first port 141 of the drain valve 104, through the drain valve 104 and the drain pipe 113 to a suitable disposal. Switching of the positions of the inlet valve 102, the flush valve 103 and the drain valve 104, substantially simultaneously, therein provides either the primary flowpath 150 or the secondary flowpath 160 for use.

The flush media stored in the flush source 108 in this preferred embodiment is purified water. While this embodiment has been shown to include a flush source 108, it should be clearly evident to one skilled in the art that the flush source 108 containing flush media could be permanently installed or temporarily installed at the flush inlet pipe 112. Still another embodiment could include pouring flush media into the flush inlet pipe 112 as required for cleaning or cleansing of the filter cartridge 118 in the filter 101.

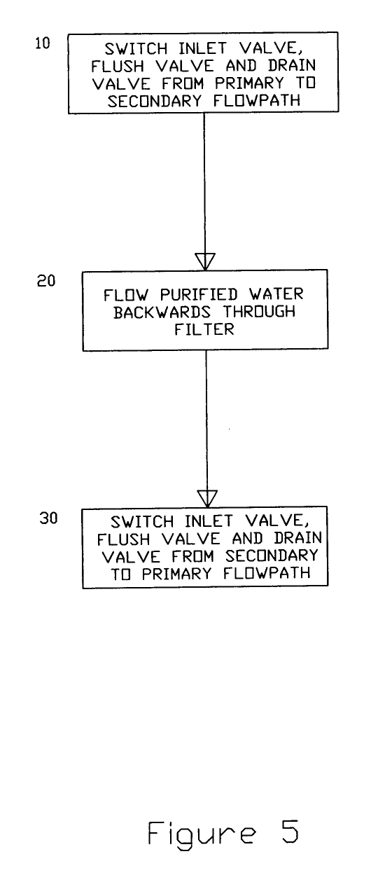

In operation, the backflush unit 100 must be changed from a non-flush state to a flush mode to execute a backflush routine. The process of going from the non-flush state to the flush mode is shown in the method flowchart of FIG. 5. The process commences with step 10, wherein the inlet valve 102 is closed to shut off the flow of fluid from the fluid source 106, and the flush valve 103 and the drain valve 104 are opened to utilize the secondary flowpath 160. As shown in step 20, the process continues with purified water flowing from the flush source 108, through the flush source pipe 112, through the flush valve 103 and into the second tee 129, therein gaining entrance to the primary or filtered flowpath 150. The purified water then flows through the first port 146 of the second tee 129, through the outlet pipe 11a, into the outlet end 115 of the filter 101, backwards through the filter 101, out the inlet end 114, through the source inlet pipe 110a, through the second port of the first tee 128, through the third port of the first tee 128, through the drain valve 104 and through the outlet pipe 113 for disposal. Upon completion of a prescribed backflushing time, one to two minutes in this preferred embodiment, the process moves to step 30, wherein the inlet valve 102, the flush valve 103 and the drain valve 104 are switched back to the primary or filtered flowpaths, 150 to stop the backflushing operation and allow fluid to again flow from the fluid source 106 to the end-use device 107. Switching of the valves in steps 10 and 30 may be accomplished manually.

The flowing of purified water backwards through the filter 101 dissolves, unclogs and removes particles embedded in the filter medium 130. The removal of particles and calcified filtered debris from the filter medium 130 increases the efficiency and life span of the filter 101. Execution of a backflush routine on a regularly scheduled basis unclogs clogged portions of the filter medium 130 and ensures the filter medium 130 will not become clogged.

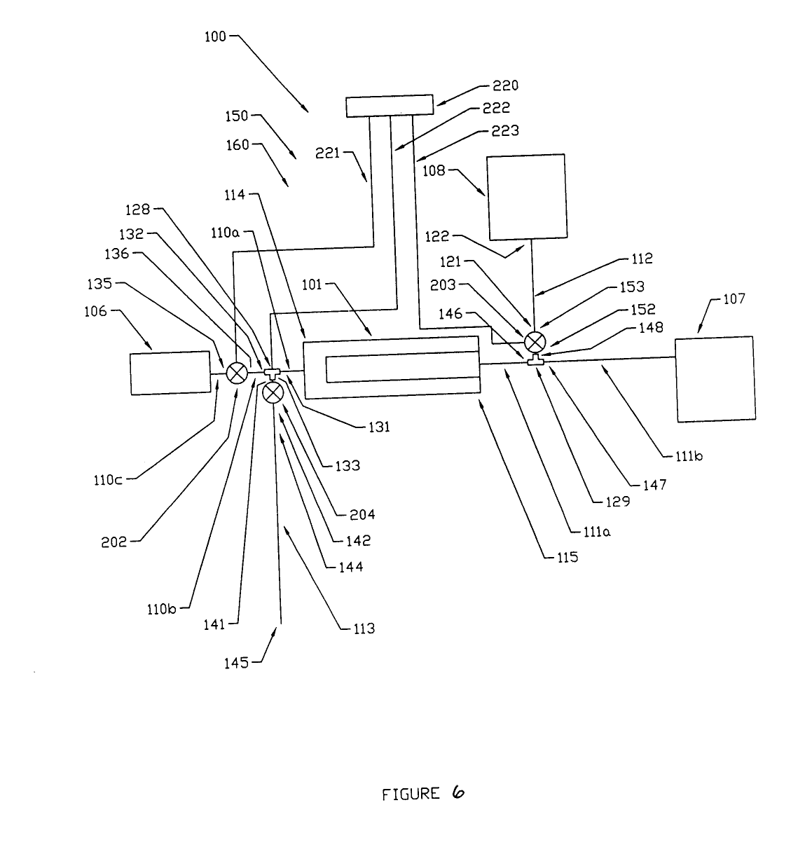

In another embodiment, a backflush unit 200 is identical to the aforementioned backflush unit 100 shown in FIG. 4, however, the addition of components allows the backflush unit 200 to execute a backflush routine on a prescribed interval. As such, similar components are marked with like numerals. As shown in FIG. 6, the backflush unit 200 further includes a controller 220, a plurality of electrically actuated valves 202, 203 and 204, a wire harness 221, 222 and 223 for each respective valve, and a power source (not shown). Hydraulically, the backflush unit 200 operates identically to the backflush unit 100, with water flowing from the source 106 to the end-use device 107 under normal operation in the primary flowpath 150. In the backflush mode, the secondary flowpath 160 allows flush media to move from the flush source 108, through the flush valve 203, through the outlet pipe 111a, backwards through the filter 101, through the inlet pipe 110a, through the drain valve 204 and through the drain pipe 113 to a proper disposal.

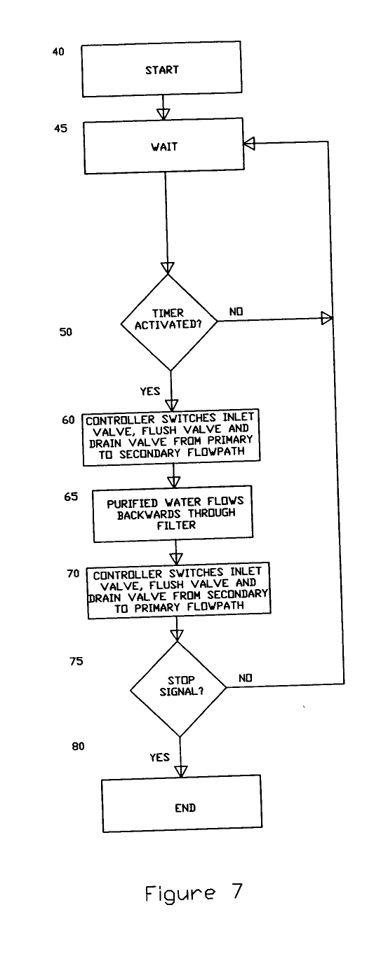

The method steps for using the backflush unit 200 are show in FIG. 7. The process commences with a start command as shown in step 40. In step 45, the controller 220 is in a wait state. The process then moves to step 50, wherein the controller 220 checks for timer activation. If the timer has not been activated in step 50, the controller 220 returns to step 45. If the timer has been activated in step 50, the controller 220 moves to step 60, wherein the controller 220 sends signals to switch the flowpaths, wherein the inlet valve 202 is closed, and the flush valve 203 and the drain valve 204 are opened to move the system flow from the primary flowpath 150 to the secondary flowpath 160.

After changing to the secondary flowpath 160, purified water flows from the flush source 108, through the flush source pipe 112, through the flush valve 203, through the outlet pipe 111a, backwards through the filter 101, through the inlet pipe 110a, through the drain valve 204, and through the drain pipe 113 to a proper disposal as shown in step 65. After the flush has been activated for a predetermined interval, one to two minutes in this preferred embodiment, the controller 220 moves to step 70, wherein the controller 220 switches the system to the primary flowpath 150 to allow water to flow from the water source 106 to the end-use device 107. The process then moves to step 75, wherein the controller 220 checks for a stop signal. If a stop signal has not been noted, the process returns to step 45, wherein the controller 220 waits for activation of the timer. The controller 220 will continue to activate and deactivate the flush mode on a predetermined interval, approximately every six hours in this preferred embodiment. If a stop signal has been noted, the process will move to step 80, where it will end.

Controller 220, in this preferred embodiment includes a microcontroller, associated hardware and software, timer mechanisms, and the like. Further extensions of this embodiment include programmable software routines for customization of backflushing subroutines in a water treatment system. While this invention has been shown with three valves, it should be clearly evident to one skilled in the art that the number of valves and flow lines may be adjusted to accommodate various types of water systems and components. Power requirements for this invention may include the unit operating with antintegral power source, a separate power source or the backflush unit 100 may be slaved off of an existing power supply in an associated water treatment system component.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A method of cleansing a filter, comprising;
providing a source of purified water; and
exposing the filter to the purified water.

2. The method of claim 1, wherein the filter includes a filter cartridge.

3. The method of claim 1, wherein the purified water includes water treated by a reverse osmosis, a steam distillation or a deionization process.

4. The method of claim 1, wherein the purified water includes water having a lower total dissolved solids reading than water being filtered.

5. The method of claim 1, wherein the purified water has a total dissolved solids reading at least fifty percent less than water being filtered.

6. The method of claim 1, wherein the purified water has a total dissolved solids reading at least eighty percent less than water being filtered.

7. The method of claim 1, wherein the purified water has a total dissolved solids reading at least ninety five percent less than water being filtered.

8. The method of claim 1, further comprising;
backflushing the filter with the purified water.

9. An apparatus for cleansing a filter, comprising:
a source of purified water; and
a container for the purified water to expose a filter to the purified water.

10. The apparatus of claim 9, wherein the container includes a tank for submersing the filter.

11. The apparatus of claim 9, wherein the container includes a pressurized source of purified water to cleanse the filter.

12. The apparatus of claim 11, wherein the container includes a pressurized source of purified water to backflush the filter.

13. The apparatus of claim 9, wherein the purified water includes water treated by a reverse osmosis, a steam distillation or a deionization process.

14. The apparatus of claim 9, wherein the purified water includes water having a lower total dissolved solids reading than water being filtered.

15. The apparatus of claim 9, wherein the purified water has a total dissolved solids reading at least fifty percent less than water being filtered.

16. The apparatus of claim 9, wherein the purified water has a total dissolved solids reading at least eighty percent less than water being filtered.

17. The apparatus of claim 9, wherein the purified water has a total dissolved solids reading at least ninety five percent less than water being filtered.

18. A filter backflush unit, comprising:
a filter, having an inlet end and an outlet end in a filtered flowpath;
a flush valve having an open and a closed position, coupled to the filtered flowpath after the outlet end;
a drain valve having an open and a closed position, coupled to the filtered flowpath before the inlet end;
an inlet valve having an open and a closed position in the filtered flowpath prior to the drain valve; and
a flush source containing water purified through a reverse osmosis, steam distillation or deionization process, wherein the flush source is coupled to the flush valve to allow a flow of the purified water to pass through the flush valve, into the outlet end of the filter, and backwards through the filter, therein exiting through the drain valve when the inlet valve is in a closed position and the flush valve and drain valve are in an open position.

19. The filter backflush unit recited in claim 18, wherein the flush valve, the inlet valve and the drain valve each comprise a solenoid operated flow control valve.

20. The filter backflush unit recited in claim 19, further comprising a controller adapted to control said inlet valve, said flush valve and said drain valve.

21. The filter backflush unit as recited in claim 20, wherein said controller comprises a microcontroller.

22. The filter backflush unit as recited in claim 21, wherein said controller is adapted to periodically operate said valves to execute a backflush routine.

23. A filter backflush unit, comprising:
a filter, having an inlet end and an outlet end in a filtered flowpath;
a flush valve having an open and a closed position, coupled to the filtered flowpath after the outlet end;
a drain valve having an open and a closed position, coupled to the filtered flowpath before the inlet end;
an inlet valve having an open and a closed position in the filtered flowpath prior to the drain valve; and
a flush source containing purified water having a total dissolved solids reading less than that of the water normally being filtered in the filtered flowpath, wherein the flush source is coupled to the flush valve to allow a flow of the purified water to pass through the flush valve, into the outlet end of the filter, and backwards through the filter, therein exiting through the drain valve when the inlet valve is in a closed position and the flush valve and drain valve are in an open position.

24. The filter backflush unit of claim 23, wherein the water used in the backflushing has a total dissolved solids reading at least fifty percent less than the total dissolved solids reading of the water being filtered in normal dispensing operations.

25. The filter backflush unit of claim 23, wherein the water used in the backflushing has a total dissolved solids reading at least eighty percent less than the total dissolved solids reading of the water being filtered in normal dispensing operations.

26. The filter backflush unit of claim 23, wherein the water used in the backflushing has a total dissolved solids reading at least ninety five percent less than the total dissolved solids reading of the water being filtered in normal dispensing operations.

27. The filter backflush unit recited in claim 23, wherein the flush valve, the inlet valve and the drain valve each comprise a solenoid operated flow control valve.

28. The filter backflush unit recited in claim 27, further comprising a controller adapted to control said inlet valve, said flush valve and said drain valve.

29. The filter backflush unit as recited in claim 28, wherein said controller comprises a microcontroller.

30. The filter backflush unit as recited in claim 28, wherein said controller is adapted to periodically operate said valves to execute a backflush routine.

31. A filter backflush unit comprising,
a primary flowpath; wherein the primary flowpath is used for normal dispensing operations; and
a secondary flowpath, wherein the filter backflush unit switches from the primary flowpath to the secondary flowpath to execute filter backflushing routines with a flow of water purified using a reverse osmosis, steam distillation or deionization process.

32. A filter backflush unit comprising,
a primary flowpath; wherein the primary flowpath is used for normal dispensing operations; and
a secondary flowpath, wherein the filter backflush unit switches from the primary flowpath to the secondary flowpath to execute filter backflushing routines with a flow of water having a total dissolved solids reading less than the total dissolved solids reading of the water being filtered in normal dispensing operations.

33. The filter backflush unit of claim 32, wherein the water used in the backflushing has a total dissolved solids reading at least fifty percent less than the total dissolved solids reading of the water being filtered in normal dispensing operations.

34. The filter backflush unit of claim 32, wherein the water used in the backflushing has a total dissolved solids reading at least eighty percent less than the total dissolved solids reading of the water being filtered in normal dispensing operations.

35. The filter backflush unit of claim 32, wherein the water used in the backflushing has a total dissolved solids reading at least ninety five percent less than the total dissolved solids reading of the water being filtered in normal dispensing operations.

36. A method for backflushing a filter, comprising;
a. switching an inlet valve, a drain valve and a flush valve in a filtered flowpath from a primary flowpath used for dispensing operations to a secondary flowpath, therein allowing purified water into the filtered flowpath;
b. flowing the purified water in the secondary flowpath, wherein the secondary flowpath allows the purified water to flow backwards through the filter for a predetermined interval to remove or dissolve filtered media or unclog a filter in the primary flowpath; and
c. switching the inlet valve, the drain valve and the flush valve from the secondary flowpath to the primary flowpath to resume dispensing operations.

37. The method for backflushing a filter as recited in claim 36, further comprising;
d. Repeating steps a.-c. to provide a continued cleansing of the filter medium.

38. The method of claim 36, wherein the purified water includes water treated by a reverse osmosis, a steam distillation or a deionization process.

39. The method of claim 36, wherein the purified water includes water having a lower total dissolved solids reading than water being filtered.

40. The method of claim 36, wherein the purified water has a total dissolved solids reading at least fifty percent less than water being filtered.

41. The method of claim 36, wherein the purified water has a total dissolved solids reading at least eighty percent less than water being filtered.

42. The method of claim 36, wherein the purified water has a total dissolved solids reading at least ninety five percent less than water being filtered.
